(19) United States
(12) Patent Application Publication
(10) Pub. No.: US 2012/0027150 A1
(43) Pub. Date: Feb. 2, 2012

(54) High flux fast neutron generator

(75) Inventor: Ryoichi Wada, College Station, TX (US)

(73) Assignee: RYOICHI WADA, COLLEGE STATION, TX (US)

(21) Appl. No.: 12/804,916

(22) Filed: Aug. 2, 2010

(51) Int. Cl. G21B 1/00

(52) U.S. Cl. 376/127

(57) ABSTRACT

High flux neutron generator for fast neurons is invented, using a cylindrical inertial electrostatic confinement (Cylindrical IECF) fusion reactor. In order to achieve high flux (more than 10¹⁶ neutrons/sec), the existing IECF device is modified in following four points: 1) cylindrical shape, instead of spherical, 2) ring high voltage terminal at the center, instead of spherical grid, 3) internal ion injection, instead of glow discharge or external injection, 4) under magnetic field operation. The geometrical shapes and locations of the electrodes and the ion injection housing, including their voltages, are optimized by computer simulations. According to the simulations, ˜10¹⁶ neutrons/sec can be generated for the d+t fusion reaction with 1 ampere of ion injection under the vacuum pressure better than 10⁻⁸ torr.

### U.S. PATENT DOCUMENTS

| | | |
|---|---|---|
| 3,530,497 A | September 1970 | Hirsch et al. |
| 3,533,910 A | October 1970 | Hirsch |
| 7,550,741 B2 | June 2009 | Sanns |

### STATEMENT REGARDING COPYRIGHT MATERIAL

Portion of the disclosure of this patent document contains material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### FIELD OF INVENTION

The invention generally relates to neutron generator, more specifically to a device and method of fast neutron generation, and further more precisely to a cylindrical Inertial Electrostatic Confinement Fusion (IECF) reactor with a terminal ring electrode.

### BACKGROUND

Fast neutrons have been used in many application fields, ranging from neutron activation analysis, boron neutron capture cancer therapy, mine and petroleum exploration, security screening and landmine detection, radiography or tomography of thick materials. For these applications, moderate intensity of neutrons (˜10¹⁰-10¹⁶ neutrons/s) is required.

The technology for producing fast neutrons with such intensities, is also used in varieties of ways; spontaneous fission sources device, ion-source driven neutron generators including neutron tubes, inertial electrostatic confinement devices.

In the last two decades much powerful fast neutron generators have been spotlighted for nuclear power generator and waste transmutation. For this purpose, the intensity in the range of more than 10¹⁹ neutrons/s is required for the practical usage. Accelerator-driven device, plasma fusion-driven device, and inertial confinement devices have been considered.

As for such high intensity neutron drivers, a practical size of the fusion devices or accelerators has been proposed. However such devices are very expensive and a significant amount of research and development is still necessary. An alternative device proposed here is an improved Inertial Electrostatic Confinement Fusion (IECF) device.

The IECF devices are based on a collider concept between ions, which are confined in an electrostatic field. Good descriptions about the existing IECF devices are found in Refs. 1-4.

In the IECF devices, fast neutrons have been generated, using the following reactions.

d+d→n+h+3.3 MeV (1)

d+t→n+α+17.6 MeV

with Deuterium gas, and Deuterium and Tritium mixed gases as the fuel gas, respectively. n, p, d , t, h and α represent neutron, proton, deuteron, triton, helium-3 and alpha particles, respectively. The energy added at the end of each reaction is the reaction Q-value, which is carried away by the ejected particles.

The existing IECF devices can generate neutrons with a typical flux of 10⁶-10⁸ neutrons/s using the reactions (1), which is far below the flux needed for nuclear energy or waste programs.

Most of the existing IECF devices have two concentric spherical grids inside a spherical vessel, which is used as a spherical vacuum container. In many applications, the outer grid is replaced by the spherical vessel itself and not used.

Cylindrical shapes have also used for the outer grid and/or outer vessel in some devices, but the essential principle of neutron generation remains unchanged. In the following, therefore, firstly the existing IECF devices are discussed for the spherical type. All discussions can be applied to the cylindrical devices. Then a proposed improved design is presented in the next section.

The inner grid is biased at several tens kV. The outer grid (or vessel) is at the ground potential. Therefore between two potentials, concentric spherical electric field is created and ions are accelerated or decelerated along a radial direction by the field.

Ions are generated between the two grids by glow discharge or by ions from external ion source(s) injected through windows on the spherical vessel wall from outside. In both cases the fuel gas is filled inside the vessel at the pressure of about 10⁻² to 10⁻⁵ torr (1.3 Pa to 1.3 mPa).

The generated ions are accelerated toward the inner grid by the radial electric field. Since the fusion reaction probability is very small, most ions pass through the inner grid and appear on the other side, and then they are decelerated toward the outer grid. Before passing through the outer grid, the ions stop and return toward the inner grid again. The ions repeat this back and forth inertial motion until a fusion reaction occurs or the ion hits the inner terminal grid and is neutralized.

Fusion reaction occurs by a collision between two injected ions which are moving opposite directions each other. Most of the reaction occurs inside the inner grid in which the ion density becomes the maximum.

Since ions are positively charged, the ion trajectory is often deflected by Coulomb scatterings between ions during the trip before a fusion reaction occurs, causing that the ions hit the inner grid and are lost.

Since the fusion probability is so small, ions travel back and forth through the inner grid many times. Therefore as the number of the trips increases, the fusion probability increases. In order to maximize the number of trips, the grid is made of a fine wire or a thin metal plate to maximize the transparency. The typical transparency used in the existing device is 99% at most. Therefore the average number of ion trips is about 100 at maximum.

The fusion probability of an ion, P_{F}, is given by

P_{F}=C·N·σ, (4)

for one trip of the ion from one end to the other. C is a constant. N is the number of opponent colliding ions which is same as the number of generated ions by glow discharge or by externally injected ions. a is the average fusion cross section along the trajectory path.

The total number of fast neutrons generated by all injected ions for one trip is given by

$$\begin{matrix}{N}_{F} = N \cdot {P}_{F} \\ = C \cdot {N}^{2} \cdot σ\end{matrix} \qquad ( 5 )$$

N² in Eq. (5) reflects the fact that the generated ions contribute both as the injected ion and as the opponent colliding ion in the IECF device, which results from the collider concept.

If each ion makes an average number of trips of n times, the injected ion and the opponent colliding ion both contribute to the fusion probability by n times, and therefore the total number of generated neutrons becomes

N_{F}=C·(nN)²·σ.

The existing IECF devices generate about 10⁶ to 10⁸ neutrons/s with n˜100. If the number of trips increases from 100 to 10⁶ (1 million), N_{F} increases by a factor of (10⁴)²=10⁸, that is, the output neutron intensity becomes 10¹⁴-10¹⁶ neutron's, if the same number of ions is initially injected.

Therefore the key of this invention is to design an IECF device in which ions are able to travel more than one million trips from one side to the other through the terminal electrode.

### SUMMARY OF THE INVENTION

In the invented device, both concepts of the collider and the inertial electrostatic confinement are kept same as those of the spherical IECF devices, and the following five modifications are made.

1. The spherical vessel is replaced by a cylindrical vessel 4 and the outer gird is abandoned.

2. The inner grid is replaced by a ring electrode 1.

3. The field trim electrodes 2 are added.

4. The internal injection of ions is adopted. Ions are injected from the ion source housing 3.

5. Magnetic field is applied along the axis of the cylindrical vessel using solenoids 5 located outside the vessel.

After optimizing the shape, location and voltage of the device elements using a computer simulation code, more than one million of the average number of trips has been achieved for injected ions, which results in the generation of more than 10¹⁶ neutrons/s when 1 A of deuterons and tritons is injected from the sources.

### BRIEF DESCRIPTION OF THE DRAWINGS AND FIGURES

FIG. 1-A: An optimized device is shown. To see inside the device, the half of the right hand side of the electrodes and the cylindrical vessel are shown as cross sections in which the cut is made in the vertical plane. Individual elements are: 1; ring terminal electrode which is negatively biased at V_{T}. 2; field trim electrodes. 3; ion source housings. 4; cylindrical vacuum vessel. 5; solenoids. High voltage leads, terminal supports and ion source(s) are not shown. Vacuum pumping units and power supplies are not shown.

FIG. 1-B: X-Z plane view (see coordinate definition in FIG. 2) of the device shown in FIG. 1-A. The same cross section view as FIG. 1 is made in the right hand side. Elements 1-5 are same as those in FIG. 1-A

FIG. 1-C: X-Y plane view (see coordinate definition in FIG. 2) of the device shown in FIG. 1. Elements 1-5 are same as those in FIG. 1-A.

FIG. 2: Two dimensional schematic drawing of the device shown in FIG. 1-A. Elements 1-5 are same as those in FIG. 1-A. 6; confinement trajectory regions. X,Z coordinates used are also shown. The direction of the ion injection from the source housings is indicated by arrows. Scale is in the case of the geometrical scaling factor, S_{F}=2.

FIG. 3. Calculated results of fusion probability as a function of the terminal voltage. The given fusion probability is the averaged value between those of deuteron and triton. The fusion probability increases as the terminal voltage increases.

FIG. 4. Calculated results for fusion probability as a function of the geometrical scaling factor, S_{F}. The fusion probability is the averaged value between those of deuterons and tritons. The fusion probability remains more or less constant when the device is scaled by a factor of S_{F}, where S_{F} is changed from 1 to 4.

### DETAILED DESCRIPTION OF THE INVENTION

In the invented device, the concepts of the collider and the inertial electrostatic confinement are kept same as the existing IECF devices, and the following modifications are made in the geometrical shapes, electric field shape, fuel, ion injection and added magnetic field.

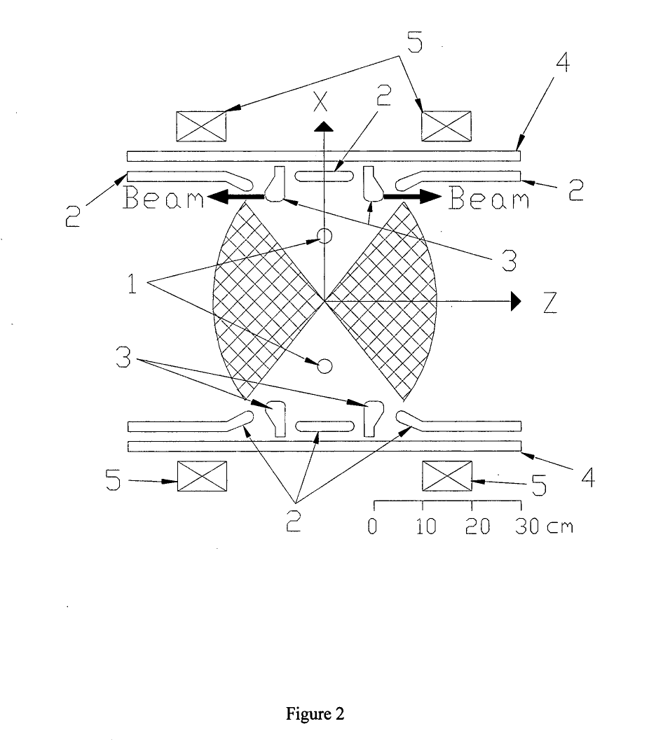

Geometrical shapes: The spherical vessel is replaced by a cylindrical vessel 4 and the outer gird is abandoned. The inner spherical grid is replaced by a ring electrode 1. These changes bring two important results. One is the creation of a confinement trajectory region 6 in FIG. 2. The second is the cooling capability for the terminal ring. This capability enables to increase the input source power significantly.

Electric field: Ellipsoidal field is created between the cylindrical vessel 4 and the ring electrode 1. This field creates the confinement trajectory region. Ions are trapped in this region and trip back and forth along the cylindrical axis until they hit the terminal electrode or making a fusion reaction. The field shape is further adjusted to maximize the number of trips using field trim electrodes 2.

Fuel: The internal injection of ions is adopted instead of the glow discharge method or external beam(s) outside the wall. In this way no fuel gas is necessary inside the vessel and therefore the vessel inside can be keep in high vacuum (better than 10⁻⁵ torr (1.3 mPa)). This high vacuum is a crucial factor to achieve more than a million trips for injected ions.

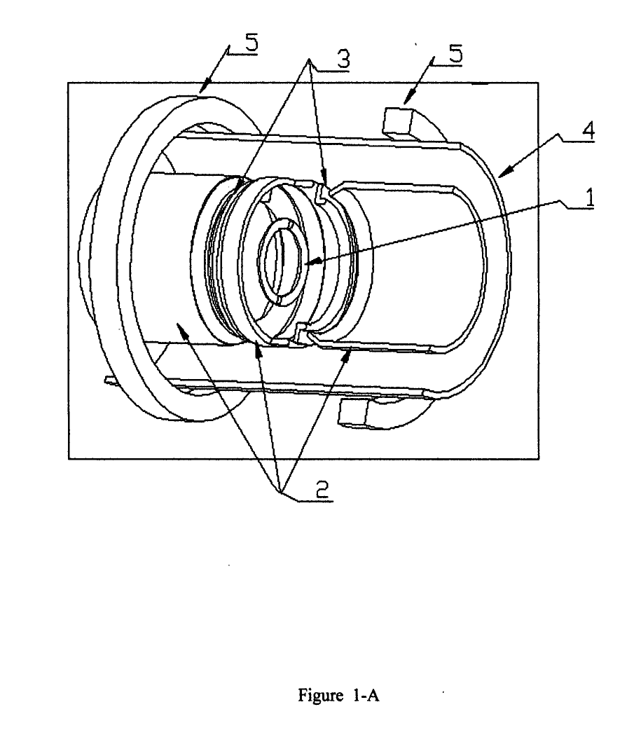

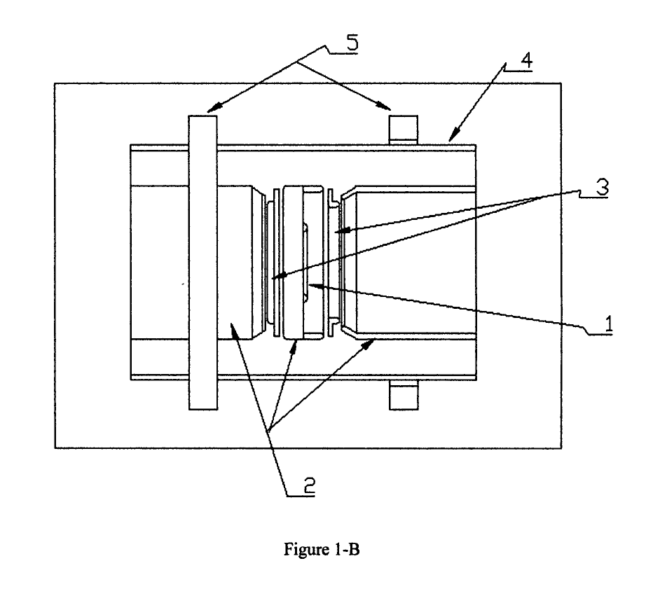

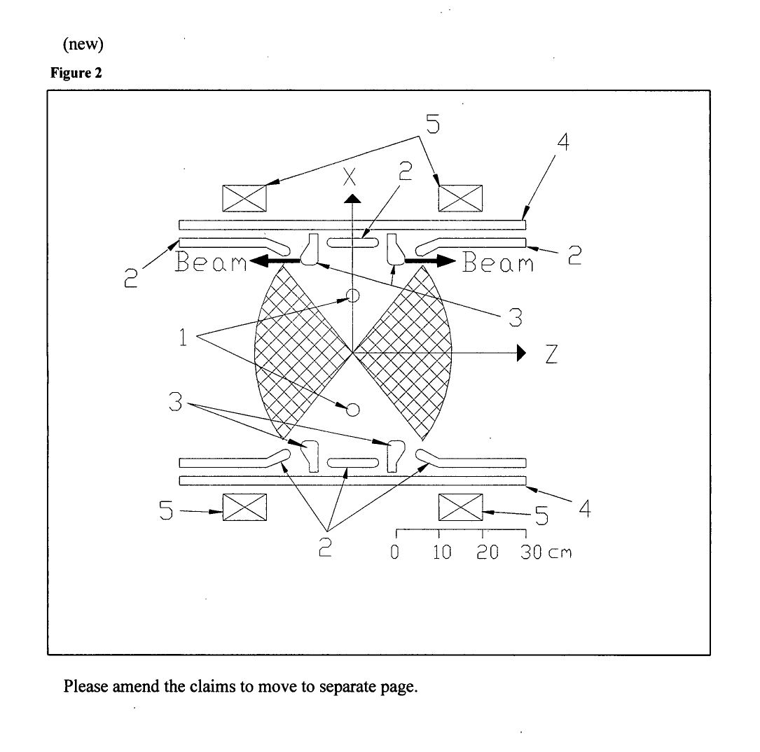

Ion injection: Ions are injected from the ion source housing 3 inside the vacuum vessel. Ions are supplied either by ion sources installed inside the housing or by external ion sources installed outside the vacuum vessel. In the latter case ions are transported through beam transport lines to the housing. The ion source housings 3 are biased so that the ions can not hit the wall energetically after passing through the terminal ring. These ion sources and the beam transport line for the external ion source are not shown in the FIG. 1-A, B, C and FIG. 2.

Magnetic field: Solenoids 5 are used to generate magnetic field along the Z axis to achieve efficient ionization of neutral gases in the confinement trajectory region.

In the invented device, the terminal voltage is applied more than −100 kV in order to minimized the termination of the trip caused by the Coulomb scatterings.

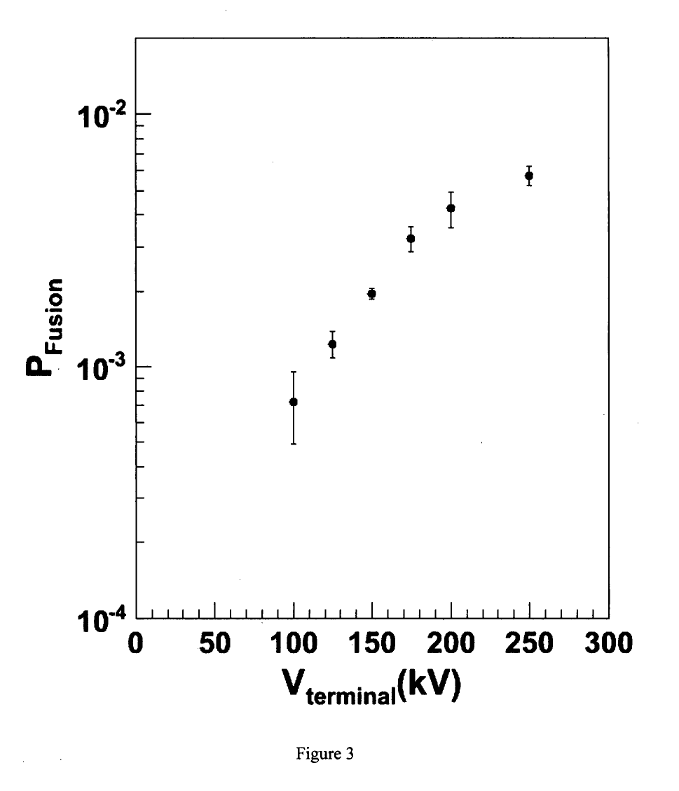

In the invented device, the geometry, location and voltages of all elements have been optimized by computer simulations, and the average number of trips more than a million times per injected ion, has been achieved. The calculated fusion probability per injected ion for an optimized device is shown in FIG. 3. Details of the simulation program and procedures are given in Ref. 5.

The calculated fusion probability is 0.1% around the terminal voltage of V_{T}=−100 kV and increases up to 0.5% at V_{T}=−250 kV.

If one can successfully inject 1 A of the ions from the deuterium and tritium mixing source(s), the number of the input ions is 6×10¹⁸ and the output number of fast neutron will be 6×10¹⁸×0.005=3×10¹⁶ at VT=−250 kV.

The device can be geometrically scaled without loosing significantly the fusion probability.

In order to demonstrate this, the geometrical scaling factor, S_{F}, is introduced. The device shown in FIGS. 1 and 2 are scaled by this factor in X, Y, Z directions.

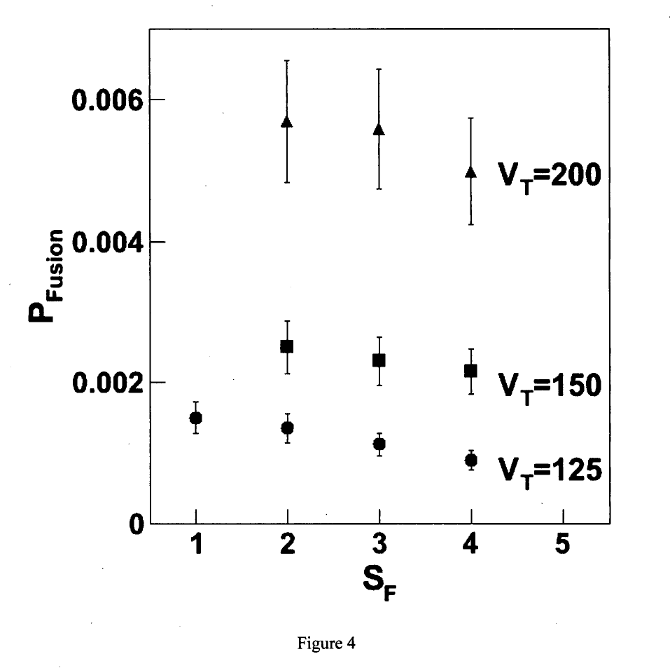

The calculated fusion probability as a function of S_{F} is shown in FIG. 4 in cases of the terminal voltage of −125, −150 and −200 kV for S_{F} up to 4. There is no theoretical upper limit for the scale factor and S_{F} can be larger. The calculated fusion probability decreases slightly as S_{F} increases in general, when the terminal voltage and vacuum pressure are kept same.

### REFERENCES

1. G. H. Miley, J. Javedani, R. Nebel, J. Nadler, Y. Gu, A. Satsangi, P. Hock, “iniertial-electrostatic confinement neutron/proton source”, in Proceeding of 3rd Int. Conf. Dense Z-Pinches, H. Hairs and A. Knight eds., AIP Conf. Proc. 299. New York: AIP Press, 675 (1994)
2. J. F. Santarius “Overview of University of Wisconsin inertial-electrostatic confinement fusion research”, Fusion Sci. Tech. 47, p1238 (2005).
3. K. Yoshikawa, K. Takiyama, Y. Yamamoto, K. Masuda, H. Toku, T. Koyama, K. Taruya, H. Hashimoto, M. Ohnishi, H. Horiike, N. Inoue, “Current Status of IEC Fusion Device for a Simple Portable Neutron/Proton Source”, The NATO ARW “Detection of Explosives and Land Mines : Method and Field Experience” (St-Petersburg, Russia, 2001).
4. T. Takamatsu, K. Masuda, T. Kyunai, H. Toku, K.Yoshikawa, “Inertial Electrostatic confinement fusion device with an ion source using a magnetron discharge”, Nucl. Fusion 46, 142 (2006).
5. R. Wada, “Cylindrical Inertial Electrostatic Confinement Fusion Reactor : Computer Simulation for High Flux Fast Neutron Generator”, Fus. Eng. Design, to be submitted, May 2010.

The invention claimed is:

1. Inertial electrostatic confinement fusion (IECF) device, comprising;
a cylindrical vacuum vessel,
a terminal ring electrode,
field trim electrodes,
internal source housings,
a means of supplying ions which are injected from the source housing,
a means of supplying high voltages,
a means of supplying cooling medium,
a means of vacuum pumping system,
a means of generating magnetic fields along the vessel axis.

2. The IECF device of claim 1, wherein the center of the terminal ring electrode is aligned to the axis of the cylindrical vessel, and the face of the terminal ring is set perpendicular to the axis at the center of the vessel.

3. The IECF device of claim 1, wherein the field trim electrodes have ring or cylindrical tubing shape and the center of the field trim electrodes is aligned to the axis of the cylindrical vessel, and the face of the ring electrodes are set perpendicular to the axis. The electrodes are set symmetrically to the terminal ring on both sides inside the cylindrical vessel. The terminal ring and these electrodes create a confinement trajectory region for ions between the terminal ring electrode and the vessel wall.

4. The IECF device of the claim 1, wherein the source housing have ring or cylindrical tubing shape and the center of the source housings is aligned to the axis of the cylindrical vessel and the face of the source housings are set perpendicular to the axis. Two identical sets of the source housings are set symmetrically to the terminal ring on both sides inside the vessel.

5. The IECF device of the claim 1, wherein the supplied ions are ejected from the source housings at the optimized direction and energy.

6. The IECF device of the claim 1, wherein the ions are supplied either by internal ion sources installed inside the source housings or by external ion sources installed outside the cylindrical vessel in which ions are transported to the housing through beam lines.

7. The IECF device of the claim 1, wherein the supplied high voltages are used to bias the terminal ring, the ring electrodes and the source housings. The terminal ring is biased at −100 kV to −1 MV. The housings and field trim electrodes are biased at optimum operation voltages.

8. The IECF device of the claim 1, wherein the terminal ring, and/or the source housing and/or the electrodes are cooled by the cooling medium.

9. The IECF device of the claim 1, wherein the vessel is kept in high vacuum (P<10−6 torr (1.3 mPa)) using the vacuum pumping system.
